(19) United States
(12) Patent Application Publication
(10) Pub. No.: US 2007/0276904 A1
(43) Pub. Date: Nov. 29, 2007

(54) Information processing apparatus, information processing method and computer readable information recording medium

(75) Inventor: Hiroyuki Satou, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/525,900

(22) Filed: Sep. 25, 2006

(30) Foreign Application Priority Data
May 25, 2006 (JP) 2006-145671

(51) Int. Cl. G06F 15/16

(52) U.S. Cl. 709/203

(57) ABSTRACT

An information processing apparatus for evaluating information which is submitted to an information display apparatus which a user operates, the information including characters and images, includes a state obtaining part obtaining at least any one of the number of the characters and the number of the images; a reading time obtaining part obtaining the user's reading time on information; and a reading time calculating part calculating, with the use of at least any one of the number of the characters and the number of the images, a reading time per character/image.

### BACKGROUND OF THE INVENTION

1. Field of the Invention

The present invention relates to an information processing apparatus, an information processing method and a computer readable information recording medium, and, in particular, to an information processing apparatus as a client computer by which information is received from a server computer and then, the information is submitted to a user of the client computer, an information processing apparatus as the server computer, an information processing method carried out by the information processing apparatus and a computer readable information recording medium storing a program for causing the computer to carry out the information processing method.

2. Description of the Related Art

As one example of the information provided by the server computer, a so-called Web page, which is provided via a communication network such as the Internet, is known.

For operating the server computer to provide such a Web page, in order to know how the Web page is handled by the client side, it is demanded to collect and analyze behaviors of the users who read the Web page, to know whether the Web page or which its contents thereof attracts users' attentions, and thus, to develop effective contents, to know such a location of an advertisement banner in the Web page which most effectively attracting the users' attentions, and so forth.

Japanese Laid-open Patent Applications Nos. 2005-182364, 2002-169708 and 2001-51925 disclose related arts.

### SUMMARY OF THE INVENTION

In order to collect and analyze the behaviors of users who read the Web page, to know whether the Web page or which its contents thereof attract the users' attentions, and thus, to develop effective contents, to know such a location of an advertisement banner in the Web page most effectively attracting the users' attentions, and so forth, the present invention has been devised to provide a configuration by which how much a user is attracted attention by each information provided by a server computer, can be easily and effectively obtained.

In order to achieve the object of the present invention, at least any one of the number of the characters and the number of the images included in the information provided by the server is obtained, the user's reading time on the provided information is obtained, and then, with the use of at least any one of the number of characters and the number of the images thus obtained, a reading time per character/image is calculated.

According to the present invention, as a result of at least any one of the number of characters and the number of images included in the information provided by the server computer, and the user's reading time on the provided information, being thus obtained, and then, the reading time per character/image being thus calculated therefrom, it is possible to effectively obtain the user's state of reading the information.

That is, only from the number of how many times the provided information has been accessed by users, it may not necessarily be possible to accurately know how much the information has been actually read by the users. Further, only from obtaining the user's reading time on the provided information for each time of the access, it may not be possible to know how much the user is actually attracted his or her attention by the provided information, accurately, since the amount of contents included in each particular provided information provided may vary.

According to the present invention, in addition to the user's reading time on the provided information, at least any one of the number of characters and the number of images included in each provided information is obtained. Then, therefrom, the reading time per character/image is calculated. That is, even if the user's reading time on the provided information is relatively small, the actual degree of how much the user is attracted his or her attention by the provided information may not necessarily be so low, when the number of characters and the number of images actually included in the provided information themselves are also relatively small. Further, on the contrary, even when the user's reading time on the provided information is relatively long, the actual degree of how much the user is attracted his or her attention by the provided information may not necessarily be so high, when the number of characters and the number of images included in the provided information themselves are also relatively large.

Furthermore, in a case where the user's reading time on the provided information is very long although the number of characters and the number of images included in the provided information are not so large, it may be doubtful that the user has actually read the provided information. That is, in such a case, the user may have paid his or her attention rather to another thing even while the Web page, which has provided the above-mentioned provided information, has been displayed on the screen the client computer. Accordingly, preferably, such a factor should also be considered to determine the actual degree of how much the user has been attracted his or her attention by the provided information.

Further, it is also preferable that, whether or not the user has made screen scrolling operation during the user's reading time on the provided information is obtained. This is because, from such screen scrolling operation being made by the user, it may be presumed that the user is attracted his or her attention by the provided information.

Thus, by the present invention, it is possible to effectively measure the degree of how much the user is attracted his or her attention by the provided information, and thus, it is possible to easily and positively know how much the provided information is beneficial to the user.

### BRIEF DESCRIPTION OF THE DRAWINGS

Other objects and further features of the present invention will become more apparent from the following detailed description when read in conjunction with the accompanying drawings:

FIG. 1 shows a functional block diagram of a Web page reading state obtaining program in one embodiment of the present invention;

FIG. 2 shows a functional block diagram of a Web page evaluating program in one embodiment of the present invention;

FIGS. 3 and 4 show a flow chart illustrating a flow of Web page reading state obtaining operation carried out according to the Web page reading state obtaining program shown in FIG. 1;

FIG. 5 shows a flow chart illustrating a flow of Web page evaluation operation carried out according to the Web page evaluation program shown in FIG. 2;

FIG. 6 illustrates an example of actually applying a Web page reading state obtaining method and a Web page evaluating method in the embodiments of the present invention;

FIG. 7 illustrates an example of applying processing to evaluate a Web page reading state in the Web page reading state obtaining method and the Web page evaluating method in the embodiments of the present invention; and

FIG. 8 shows a block diagram of a computer applicable for realizing the embodiments of the present invention.

### DETAILED DESCRIPTION OF THE PREFERRED EMBODIMENTS

Configurations of embodiments of the present invention will now be described in detail.

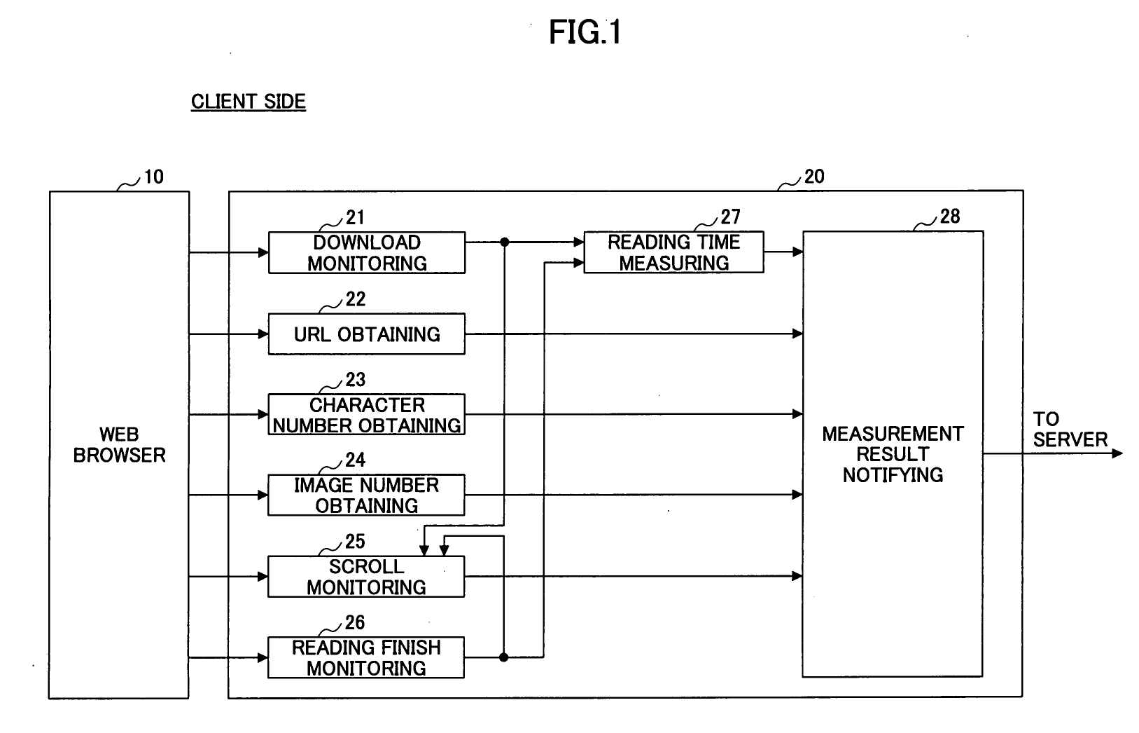

FIG. 1 shows a functional block diagram of a Web page reading state obtaining program 20 in one embodiment of the present invention.

The Web page reading state obtaining program 20 is incorporated in a Web browser 10 installed in a client computer on the side of a client, as a program module, for example.

This program 20 includes, as shown, a download monitoring part 21 for monitoring whether or not a Web page is downloaded by the Web browser 10; a URL obtaining part 22 for obtaining a URL of the Web page thus being downloaded by the Web browser 10; a character number obtaining part 23 for obtaining the number of characters included in the Web page from the Web browser 10; an image number obtaining part 24 for obtaining the number of images included in the Web page from the Web browser 10; a scroll monitoring part 25 for monitoring as to whether or not screen scrolling operation is carried out by the user during a time duration from a time at which a start of downloading of the Web page is notified of by the download monitoring part 21 to a time at which a reading finish notification is received from a reading finish monitoring part 26; the reading finish monitoring part 26 for detecting a finish of the user's reading of the Web page and issuing the reading finish notification; and a reading time measuring part 27 for measuring a time duration (corresponding to the user's reading time on the provided information) from a time at which the start of downloading of the Web page is notified of by the download monitoring part 21 to a time at which the reading finish notification is received from the reading finish monitoring part 26.

This program 20 further includes a measurement result notifying part 28 receiving the respective measurement results, i.e., the URL, the number of characters, the number of images, the occurrence/not-occurrence of the user's screen scrolling operation and the reading time (corresponding to the user's reading time on the provided information) from the URL obtaining part 22, the character number obtaining part 23, the image number obtaining part 24, the scroll monitoring part 25 and the reading time measuring part 27, then, creating reading state information therefrom, and transmitting the reading state information to a server computer (simply referred to as ‘server’, hereinafter) which has originally provided the Web page.

It is noted that the above-mentioned reading finish monitoring part 26 determines the user's reading finish of the Web page, by detecting any one of the following events:

1) the user makes operation on the client computer to finish operation of the Web browser 10; and

2) the user makes operation (including ‘link operation’, described later) on the client computer to move to another Web site (Web page).

The link operation means such operation that, by means of well-known hypertext technology or such, another file of information or such is called from one file of information, and the user can refer to the thus-called another file of information or can move thereto.

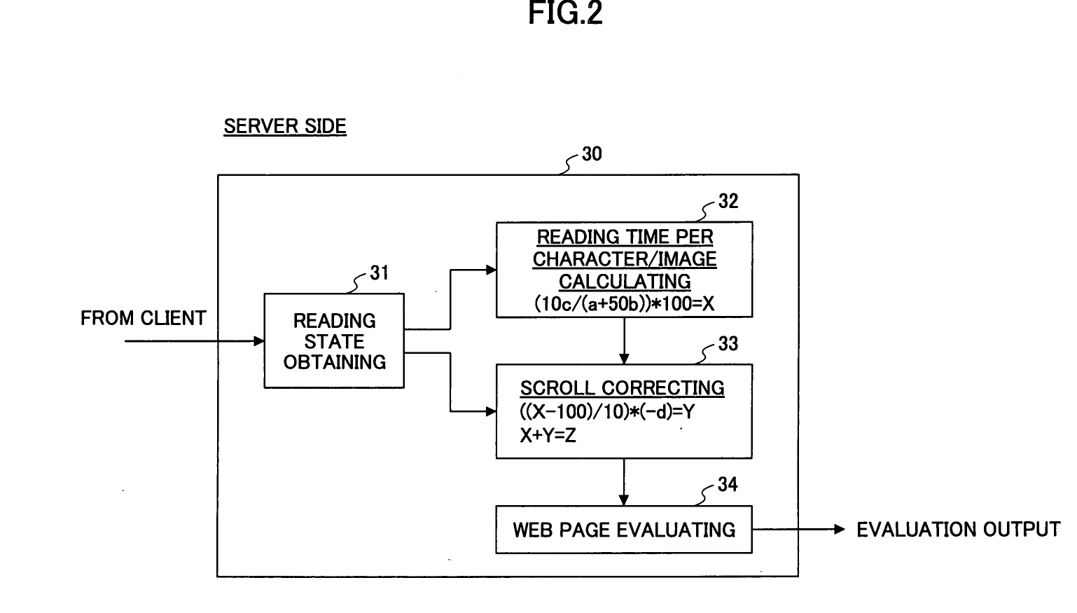

FIG. 2 shows a block diagram of a Web page evaluating program 30 in one embodiment of the present invention, which is installed in the server which provides the Web page.

This program 30 includes, as shown, a reading state obtaining part 31 for receiving the above-mentioned reading state information transmitted from the Web page reading state obtaining program 20 of the client computer via a communication network such as the Internet; a reading time per character/image calculating part 32 calculating a reading time per character/image from the measurement results included in the reading state information, i.e., the number of characters, the number of images and the reading time (corresponding to the user's reading time on the provided information); a scroll correcting part 33 for correcting the thus-calculated reading time per character/image by the scroll occurrence/not-occurrence information also included in the reading state information, and outputting the thus-corrected value (i.e., a reading time per character/image after the scroll correction) to a Web page evaluating part 34; and the Web page evaluating part 34 for receiving the reading time per character/image after the scroll correction, and, based thereon, carrying out evaluation of the Web page as to how beneficial the Web page is.

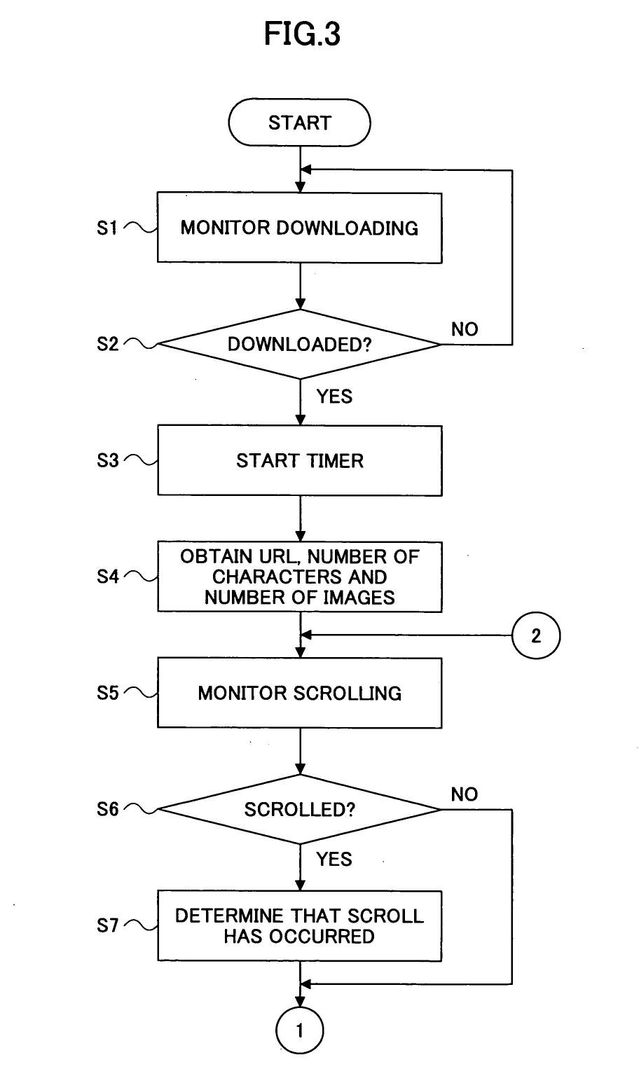

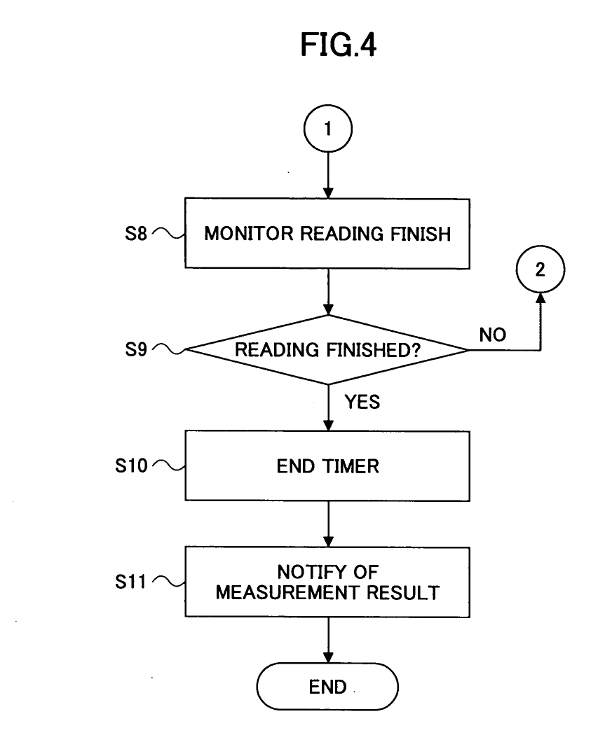

FIGS. 3 and 4 show a flow chart illustrating a flow of Web page reading state obtaining operation carried out according to the Web page reading state obtaining program 20 described above with reference to FIG. 1.

In FIG. 3, in Step S1, download monitoring is carried out by the download monitoring part 21 shown in FIG. 1. That is, when downloading of the Web page via the communication network such as the Internet is actually started, the Web browser 10 notifies the download monitoring part 21 of this fact. The download monitoring part 21 notifies the reading time measuring part 27 of this fact when receiving the notification from the Web browser 10. The reading time measuring part 27 starts a predetermined time when receiving this notification (Yes in Step S2 and Step S3).

In Step S4, the character number obtaining part 23 and the image number obtaining part 24 obtain, from the Web browser 10, information of the number of characters and the number of images, included in the Web page thus downloaded. The thus-obtained information of the number of characters and the number of images is then notified of to the measurement result notifying part 28.

Further, as described later, the character number obtaining part 23 and the image number obtaining part 24 have the following functions: That is, when the link operation is made by the user by means of a hypertext included in the Web page or such, this fact is notified of to the character number obtaining part 23 and the image number obtaining part 24 by the Web browser 10. Then, in response thereto, the character number obtaining part 23 and the image number obtaining part 24 obtains the number of characters and the number of images included in the Web page, especially in a part thereof, from the top to the hypertext, and notifies the measurement result notifying part 28 thereof.

In Step S5, the scroll monitoring part 25 monitors whether or not the user makes screen scrolling operation. When the screen scrolling operation made by the user on the client computer is detected (Yes in Step S6), the scroll monitoring part 25 makes a scroll occurring determination, and, notifies the measurement result notifying part 28 of the fact of the scroll occurrence, as one item of the above-mentioned respective measurement results (Step S7).

In Step S8 of FIG. 4, the reading finish monitoring part 26 monitors whether or not the user's reading of the Web page has finished, as mentioned above. When the reading finish is detected (Yes in Step S9), this fact is notified of to the reading time measuring part 27. The reading time measuring part 27 responds thereto, and thus, stops the predetermined timer (Step S10), and, then, the reading time measuring part 27 notifies the measurement result notifying part 28 of the measurement time thus measured by the predetermined timer as another item of the above-mentioned respective measurement results.

In Step S11, the measurement result notifying part 28 transmits, to the server which has originally provides the Web page, the reading state information based on the respective measurement results, i.e., the URL, the information of the number of characters and the number of images, notified of thereto in Step S4; the information of the scroll occurrence, notified of thereto in Step S6; and the information of the measured reading time, notified of thereto in Step S10.

It is noted that, when no screen scrolling operation has been detected by the scroll monitoring part 25 (No in Step S6), and thus Step S7 is skipped out, the above-mentioned information of scroll occurrence is not notified of to the measurement result notifying part 28.

The above-mentioned reading state information includes the above-mentioned respective measurement results, i.e., the URL, the number of characters, the number of images, the reading time and the information of the scroll occurrence, as they are. However, when the Step S7 is skipped out and thus, the information of the scroll occurrence has not been notified of to the measurement result notifying part 28, the measurement result notifying part 28 cerates information of scroll not-occurrence in this case, and includes the created information in the reading state information to be transmitted to the server. The above-mentioned information of scroll occurrence or information of not-occurrence will be referred to as a scroll value, hereinafter.

Further, in Step S4 of obtaining the number of characters and the number of images, for example, the server which provides the Web page, provides, for each Web page, the corresponding information to the Web browser 10 of the client computer, and the Web browser 10 then provides the same to the character number obtaining part 23 and the image number obtaining part 24 of the Web page reading state obtaining program 20.

Further, the server which originally provides the Web page, is once identified by the Web browser 10 when Web page is downloaded by the Web browser 10, and after that, in Step S11, the measurement result notifying part 28 of the Web page reading state obtaining program 20 transmits the reading state information to the server by means of the Web browser 10 as a return message.

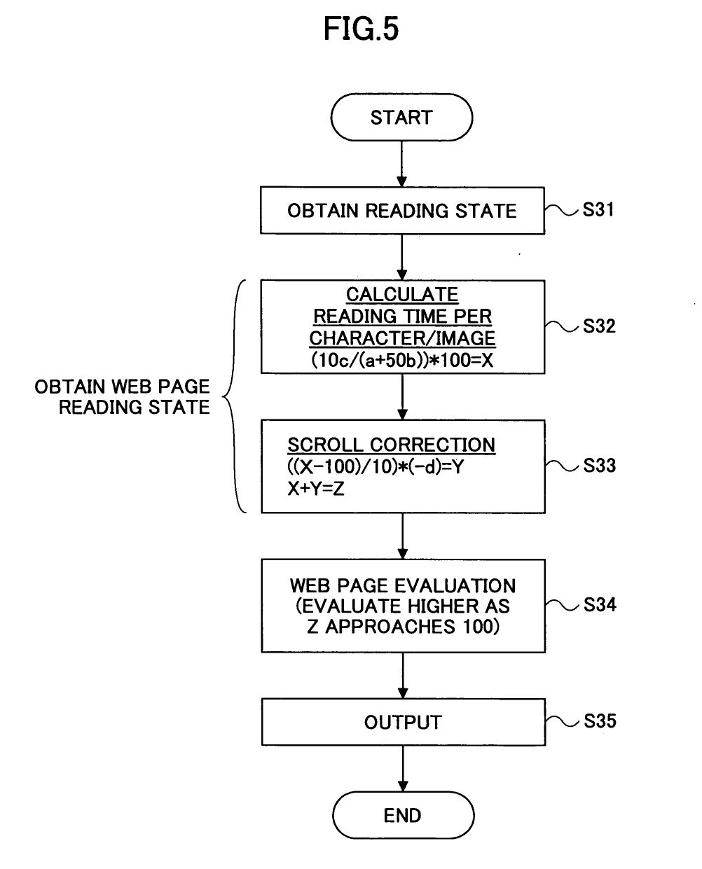

FIG. 5 shows a flow chart illustrating a flow of Web page evaluating operation carried out according to the Web page evaluating program 30 shown in FIG. 2.

In the figure, in Step S31, when the reading state obtaining part 31 receives the above-mentioned reading state information from the Web page reading state obtaining program 20 of the client computer, the reading time per character/image calculating part 32 calculates a reading time per character/image by the following formula (1):

(10c/(a+50b))×100=X (1)

In the above formula (1), c denotes the reading time (seconds), obtained by the reading time measuring part 27 of the Web page reading state obtaining program 20; b denotes the number of characters, obtained by the character number obtaining part 23 of the Web page reading state obtaining program 20; c denotes the number of images, obtained by the image number obtaining part 24 of the Web page reading state obtaining program 20; and X denotes the reading time per character/image.

For example, for a case where the Web page to evaluate includes total 100 characters and 2 images, and the reading time has been 10 seconds, a=100; b=2; c=10, and thus, the reading time per character/image X is obtained as follows:

x=(10×10/(100+50×2))×100=50

Next, in Step S33, the scroll correcting part 33 carries out scroll correction by the following formulas (2) and (3), on the reading time per character/image X obtained in Step S32:

((X−100)/10)×(−d)=Y (2)

X+Y=Z (3)

In the above formula (2), d denotes the above-mentioned scroll value. Specifically, d=+1 for the information of scroll occurrence, while d=−1 for the information of scroll non-occurrence. Z denotes the reading time per character/image after the scroll correction.

In the above-mentioned example, if the screen scrolling operation has been made by the user on the Web page and thus, the above-mentioned scroll value d=+1, X and Y are obtained as follows by the above formulas (1) and (2):

X=50

Y=((50−100)/10)×(−1)=5

In this case, the reading time per character/image after the scroll correction Z is obtained as follows:

Z=X+Y=50+5=55

Then, evaluation on the thus-obtained reading time per character/image after the scroll correction is carried out as follows:

The above-mentioned Z value is evaluated such that, as Z approaches 100 more, the reading time on the Web page is more reasonable, i.e., the Web page attracts greater attention and is more beneficial.

This is because, first, as general values, it is assumed that a general reader can read 100 characters during ten seconds, and that a general reader can view two images during ten seconds.

Under this assumption, in the above formula (1), assuming that a=100 (characters) and b=0 (images) and c=10 (seconds), X=100 is obtained. Similarly, assuming that a=0 (characters) and b=2 (images) and c=10 (seconds), also X=100 is obtained. Thus, the above-mentioned reasonable value is obtained.

As to the above formula (2), it is assumed that a case of scroll occurrence means that the Web page attracts great attention. According to this assumption, regardless of the value of X, the above-mentioned reading time per character/image (X, Z) always approaches the above-mentioned reasonable evaluation value 100 for the case of scroll occurrence, in comparison to the case of scroll not-occurrence.

For example, a case of X=50 and scroll occurrence is assumed. In this case, d=+1, and thus, the above formula (2) becomes Y=((50−100)/10)×(−(+1))=+5. Then, the above formula (3) becomes Z=50+5=55. Thus, the value X=50 changes to Z=55, and thus, it approaches 100. On the contrary, for the case of scroll not-occurrence, d=−1, and thus, the above formula (2) becomes Y=((50−100)/10)×(−(−1))=−5. Then, the above formula (3) becomes Z=50−5=45. Thus, the value becomes away from 100 in this case.

Further, for another example, a case of X=150 and scroll occurrence is assumed. In this case, d=+1, and thus, the above formula (2) becomes Y=((150−100)/10)×(−(+1))=−5. Then, the above formula (3) becomes Z=150−5=145. Thus, the value X=150 changes to Z=145, and thus, it approaches 100. On the contrary, for the case of scroll not-occurrence, d=−1, and thus, the above formula (2) becomes Y=((150−100)/10)×(−(−1))=+5. Then, the above formula (3) becomes Z=150+5=155. Thus, the value becomes away from 100 in this case.

Thus, according to the formulas (2) and (3), regardless of the value of X, the above-mentioned reading time per character/image (X, Z) always approaches the above-mentioned reasonable evaluation value 100 for the case of scroll occurrence, while, the same always becomes away from the reasonable evaluation value 100 for the case of scroll not-occurrence.

The reason why the reading time should be more reasonable as the reading time per character/image (X, Z) approaches 100, will now be described.

When this values of reading time much exceeds 100, the Web page evaluating program 30 determines that the user rather has not actually read the Web page. That is, in such a case, it is determined that, although the Web page is displayed on the screen of the client computer, the user actually carries out other job than actually reading the Web page. That is, for example, it is determined that, the user actually reads another document, and thus, it can be said that the Web page does not actually attract the user's great attention.

On the contrary, when this value of reading time much lowers from 100, the Web page evaluating program 30 determines that the user has finished the reading of the Web page soon, and thus, the Web page does not actually attract the user's great attention.

Returning to FIG. 5, in Step S34, from the reason mentioned above, the Web page evaluating program 30 determines that the Web page attracts the user's great attention and is more beneficial, when the reading time per character/image after the scroll correction Z obtained in Step S33 approaches 100 more. This evaluation result is output in Step S35.

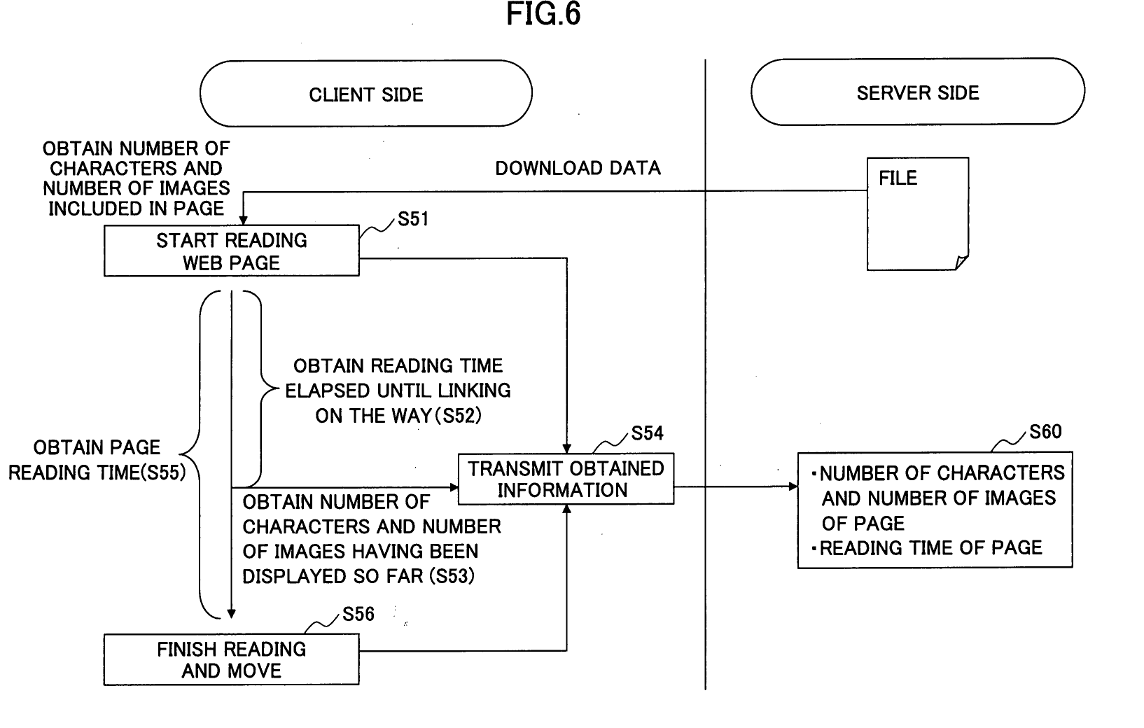

FIG. 6 illustrates an example in which the Web page reading state obtaining method and the Web page evaluating method carried out according to the Web page reading state obtaining program 20 and the Web page evaluating program 30 in the embodiments of the present invention are applied for a case where the user makes the above-mentioned link operation.

In FIG. 6, the user of the client computer downloads the data file of the Web page by means of the function of the Web browser 10, and after that, starts reading the Web page from the screen of the client computer (Step S51).

Then, the user makes link operation by a well-known manner of clicking a hypertext provided in the Web page, for example. In this case, the reading finish monitoring part 26 of the Web page reading state obtaining program 20 detected that the reading has been finished, and notifies the reading time measuring part 27 of this detection result. As a result, the reading time measuring part 27 obtains a time, having elapsed from the start of the reading (Step S51) till the above-mentioned link operation, as the reading time, and notifies the measurement result notifying part 28 thereof (Step S52).

In this case, the character number obtaining part 23 and the image number obtaining part 24 obtain the number of characters included in the part of the Web page up to the above-mentioned hypertext, i.e., the position at which the user has made the link operation, and the number of images included in the same part of the Web page, respectively. Then, these parts 23 and 24 notify the measurement result notifying part 28 of the thus-obtained number of characters and the number of images.

It is noted that, the above-mentioned information, i.e., the information indicating that the link operation has been made and the information of the number of characters and the number of images up to the position of the hypertext, is obtained from the Web browser 10. The Web browser 10 previously obtains the number of characters and the number of images, up to the position of the hypertext, from the server which has originally provided the Web page, for example. Then, when the link operation is detected, the corresponding information is provided to the Web page reading state obtaining program 20 from the Web browser 10.

On the other hand, when no link operation has been detected, the reading finish monitoring part 26 detects the user's reading finish as mentioned above, i.e., by detecting that 1) the user makes operation on the client computer to finish operation of the Web browser 10; or, 2) the user makes operation (other than link operation) on the client computer to move to another Web site (Web page). After that, the reading finish monitoring part 26 notifies the reading time measuring part 27 of this detection result. The reading time measuring part 27 then, based on the notification, obtains the reading time by means of the function of the predetermined timer, and notifies the measurement result notifying part 28 thereof.

The measurement result notifying part 28 transmits, to the server which originally provided the Web page, the respective measurement results, thus notified of in Steps S51, S52, S53, S54, S55, S56 and so forth (Step S60).

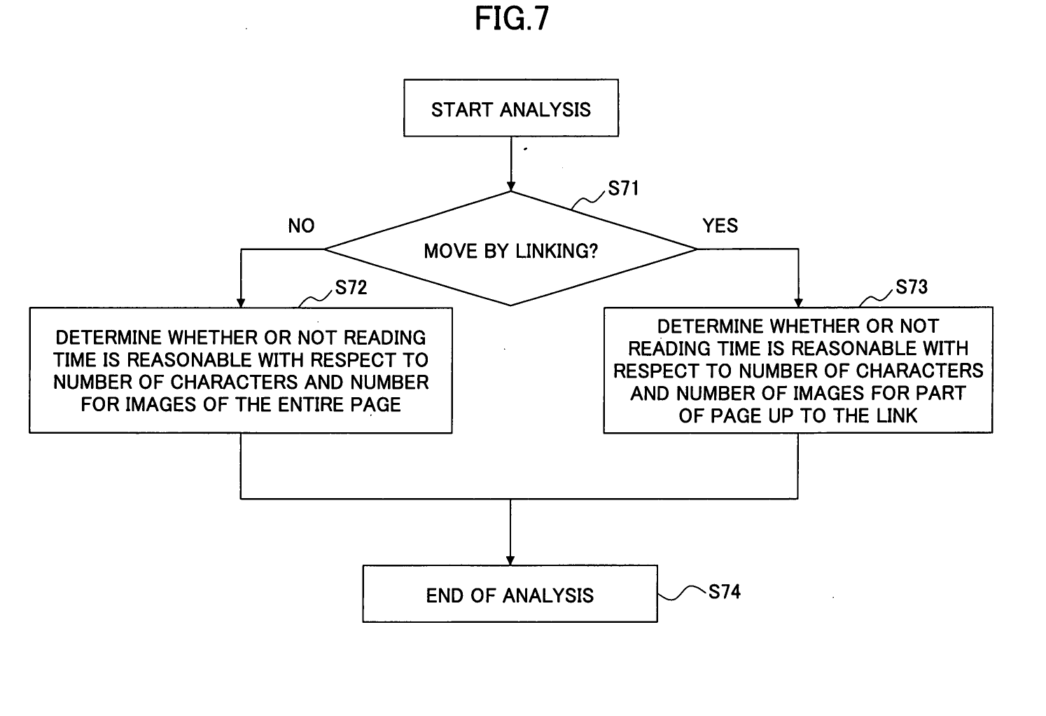

Next, with reference to FIG. 7, Web page evaluating processing carried out based on the reading state information obtained and transmitted by the Web page reading state obtaining operation, adding the factor of the link operation, described above with reference to FIG. 6, will now be described.

First, in Step S71, it is determined whether or not movement to another (second) Web page has occurred by means of the link operation of the hypertext provided in the first Web page. Specifically, it is determined that the link operation has occurred, when the elapsed time till the link operation obtained in Step S52 and the number of characters and the number of images up to the hypertext obtained in Step S53 of FIG. 6, have been notified of. On the other hand, it is determined that no link operation has occurred, when the reading finish has been detected in Step S56. For this purpose, previously, the information which indicates whether the reading state information has been obtained via Steps S52 and S53 or via Step S56 is obtained by the reading finish monitoring part 26, is then notified of to the measurement result notifying part 28, and further, is transmitted to the server from the measurement result notifying part 28.

In the above-mentioned case where no link operation has occurred, the reading time per character/image calculating part 32 calculates the reading time per character/image for the reading time for the entire Web page and the characters/images provided in the entire Web page in the above-described method with the use of the above-mentioned formulas (1), (2) and (3) in Step S72, based on the reading state information obtained by the reading state obtaining part 31. Then, the Web page evaluating part 34 evaluates the thus-obtained calculation result.

In the above-mentioned case where the link operation has occurred, the reading time per character/image calculating part 32 calculates the reading time per character/image for the reading time till the link operation and the characters/images provided in the Web page up to the hypertext concerning the link operation, according to the above-described method with the use of the above-mentioned formulas (1), (2) and (3) in Step S73, based on the reading state information obtained by the reading state obtaining part 31. Then, the Web page evaluating part 34 evaluates the thus-obtained calculation result.

As a result, as mentioned above, when the value Z of the reading time per character/image after the scroll correction is close to 100, this value is determined as reasonable, while, when the value Z is away from 100, the value is determined as no reasonable, and the processing is finished (Step S74).

It is noted that, in the above-mentioned Step S72 or S73, the above-mentioned scroll correction is carried out. That is, with the use of the scroll information included in the reading state information transmitted according to the Web page reading state obtaining program 20 of the client computer, the scroll correction is carried out with the use of the above-mentioned formulas (2) and (3). The thus-obtained value Z of the reading time per character/image after the scroll correction is then evaluated by the Web page evaluating part 34.

It is noted that, the scroll correction should not be necessarily carried out, in the embodiment of the present invention. That is, it is also possible to finally evaluate the value X of the reading time per character/image from the formula (1), without carrying out the scroll correction calculation of the formulas (2) and (3).

Thus, in the information processing apparatus (i.e., the client computer and the server computer) or the information processing method (carried out thereby) of the embodiment of the present invention, the users' behaviors on the Web page are collected and analyzed by the respective functions of the Web page reading state obtaining program 20 incorporated as the program module in the Web browser 10 of the client computer and the Web page evaluating program 30 installed in the server. Specifically, the following information is collected:

1) reading time per character/image for the characters/images included in the Web page;

2) reading time per character/image for the characters/images included in the Web page till the link operation; and

3) occurrence or not-occurrence of the user's screen scrolling operation on the Web page.

Then, the Web page evaluating program 30 analyzes the thus-collected information, and thus, determines a content part included in the Web page, which part in particular attracts the users' attentions.

That is, according to the embodiment of the present invention, in order to determine whether or not the Web page is beneficial or which part thereof is attractive, the user's reading time on the Web page is obtained. However, only from the reading time, it may not be sufficient to precisely determine whether or not or which part of the Web page actually attracts the user's attention. Therefore, the reading time per character/image is obtained. Then, from this result, the Web page evaluating program 30 determines whether or not the measured reading time actually corresponds to the amount of the contents included in the Web page.

Further, based on the thus-obtained information below, the Web page evaluating program 30 analyzes for how much the Web page is beneficial to the user.

1) the total number of characters and the total number of images included in the Web page, and the total reading time on the Web page;

2) the number of characters and the number of images included in the Web page up to the link position in the Web page, and the reading time on the Web page elapsed till the link operation; and

3) occurrence or not-occurrence of the user's screen scrolling operation on the Web page.

In a specific way to determine how much the Web page is beneficial to the user, the reading time per character/image is obtained from the above-mentioned formula (1) in order to determine whether or not the measured reading time on the Web page is reasonable with respect to the number of characters and the number of images included therein.

When the thus obtained reading time per character/image X or Z (from the above-mentioned formula (1) or (3)) lies within the range between 90 and 110 for example, the Web page evaluating program 30 determines that the measured reading time is reasonable, and thus, the Web page is beneficial to the user. On the other hand, when the value X or Z is smaller than or larger than the range between 90 and 110, the Web page evaluating program 30 determines that the measured reading time is not reasonable, and thus, the Web page is not beneficial to the user. Further, it is also possible to rank the respective Web pages according to the thus-calculated results, and to evaluate the Web pages in comparison thereamong.

Thus, in the embodiment of the present invention, in comparison to the method in the related art using the number of times of accessing the Web page collected from a log or such of the server, it is possible to determine more precisely whether or not the Web page is beneficial to the users so as to provide the contents which the users actually wish.

That is, it is possible to rank the Web pages based on the values calculated from the formulas (1), (2) and (3), or such, for determining whether or not the measured reading time is reasonable with respect to the number of corresponding characters/images, and to use it for determining the corresponding advertisement rates, for example.

The ranking of the Web pages may be used as information for the site operator to make a determination in such a manner that, for a Web page which has been thus determined as not having a high value or not beneficial to users, the site operator may make a decision to improve the contents, or such.

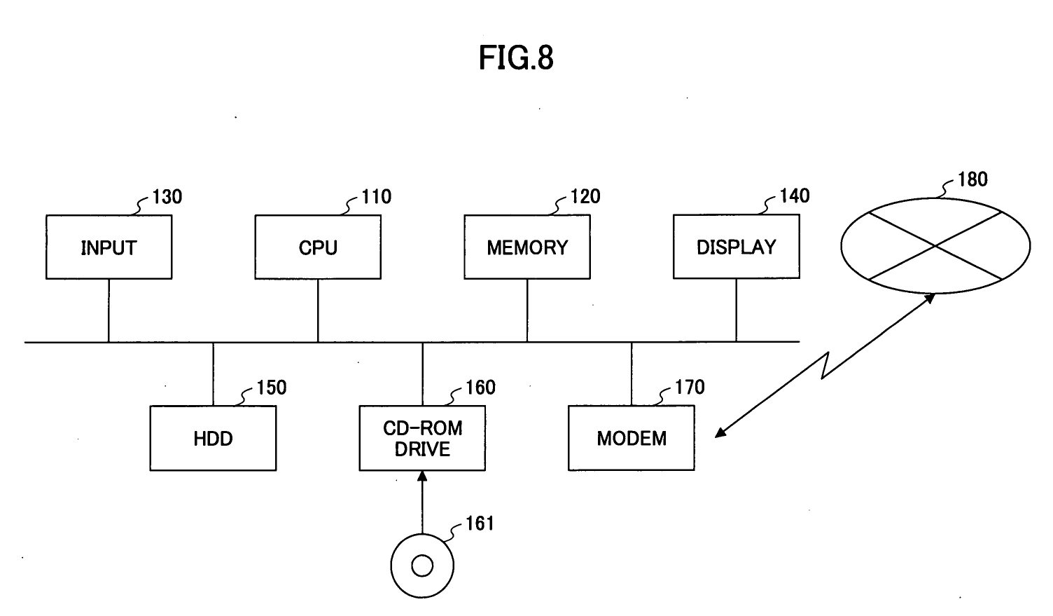

FIG. 8 illustrates the case where the information processing method or the information processing apparatus in the embodiment of the present invention is realized by the client computer as a result of the above-described Web page reading state obtaining program 20 being carried out therein, or the case where the information processing method or the information processing apparatus in the embodiment of the present invention is realized by the server computer as a result of the above-described Web page evaluating program 30 being carried out therein.

As shown in FIG. 8, each computer includes a CPU 110 for carrying out various operations by executing instructions written in the program; an input part 130 such as a keyboard, a mouse, and so forth, for the user to input operation contents or data; a display part 140 such as a CRT, a liquid crystal display device or such, for displaying, to the user, a processing progress, a processing result or such of the CPU 110; a memory 120 such as a ROM, a RAM and so forth, for storing the program to be executed by the CPU 110, or to be used as a work area of the CPU 110; a hard disk drive 150 for storing the program, data and so forth; a CD-ROM drive 160 for loading the program or data from the outside with the use of a CD-ROM 161 as an information recording medium; and a modem 170 for downloading the program or such, from an external server via a communication network 180 such as the Intent, LAN or such.

The computer loads or downloads the program having the instructions for causing the CPU 110 to acts as the respective parts 21, 22, 23, 24, 25, 26, 27 and 28 shown in FIG. 1, or the respective parts 31, 32, 33 and 34 shown in FIG. 2, and carries out the corresponding functions, appropriately according to the instructions written in the program. The CD-ROM 161 may be used as an information recording media or the communication network 180 may be used for, loading or downloading the program 20 or 30. The program is then installed in the hard disk drive 150, is loaded on the memory 120, and is executed by the CPU 110. As a result, the computer acts as the respective parts of the information processing apparatus as mentioned above, and thus, carries out the Web page reading state obtaining operation described above with reference to FIGS. 3 and 4, or carries out the Web page evaluating operation described above with reference to FIG. 5, whereby the information processing method and the information processing apparatus according to the embodiments of the present invention are realized.

In the above-described embodiments, the Web page reading state obtaining program 20 is incorporated in the Web browser 10 as the program module. However, other than this way, the Web page reading state obtaining program 20 may be provided in a form such as a program incorporated in Web page data provided by the server, or, a program which is delivered from the server in the same way as that for the Web page.

Further, in the above-described embodiments, the client computer executes the Web page reading state obtaining program 20. However, other than this way, another third computer, if any, which monitors communication between the client computer and the server computer, may execute this program. In this case, the scroll monitoring part 25 of FIG. 1 is acted by the client program and thus, screen scrolling operation on the client program by the user is thus monitored, the monitoring result being then notified of to the sever computer or to the third computer. Further, in this case, the reading finish monitoring part 26 detects finish of communication between the client and the server to determine the reading finish.

The present invention is not limited to the above-described embodiments, and variations and modifications may be made without departing from the basic concept of the present invention claimed below.

The present application is based on Japanese Priority Application No. 2006-145671, filed on May 25, 2006, the entire contents of which are hereby incorporated herein by reference.

What is claimed is:

1. An information processing apparatus for evaluating information which is submitted to an information display apparatus which a user operates, said information comprising characters and images, comprising:
a state obtaining part obtaining at least one of the number of said characters and the number of said images;
a reading time obtaining part obtaining the user's reading time on said information; and
a reading time calculating part calculating, with the use of at least one of said number of said characters and said number of said images, a reading time per character/image.

2. The information processing apparatus as claimed in claim 1, further comprising:
an operation information obtaining part obtaining operation information concerning operation of the user made on said information display apparatus, wherein:
said reading time calculating part corrects the reading time per character/image, with the use of said operation information.

3. The information processing apparatus as claimed in claim 2, wherein:
a state of said information, said reading time on the information or said operation information is transmitted from said information display apparatus.

4. The information processing apparatus as claimed in claim 2, wherein:
said reading time calculating part carries out calculation of the following formula:
(10c/(a+50b))×100=X
where ‘a’ denotes said number of characters; ‘b’ denotes said number of images; and ‘c’ denotes said user's reading time; and
carries out calculation of the following formula:
((X−100)/10)×(−d)=Y
X+Y=Z
where ‘d’ denotes occurrence/not-occurrence of said operation information, d=1 when said operation information has been given, while d=−1 when said operation information has not been given.

5. The information processing apparatus as claimed in claim 1, wherein:
when the reading time per character/image calculated by said reading time calculating part is equal to or more than a predetermined value, it is determined that the user has not actually read said information.

6. The information processing apparatus as claimed in claim 1, wherein:
said information comprises link information prepared for the user to link to other information.

7. The information processing apparatus as claimed in claim 6, wherein:
said reading time calculating part calculates the reading time per character/image based on at least any one of the number of characters and the number of images provided from the top to the link information provided in said information when the user has read said other information with the use of said link information.

8. The information processing apparatus as claimed in claim 6, wherein:
said reading time calculating part calculates a time duration from a time at which the user has started reading said information to a time at which the user has started reading said other information with the use of said link information, as the reading time on said information.

9. An evaluating method for evaluating information which is submitted to an information display apparatus which a user operates, and comprises characters and images, comprising the steps of:
a state obtaining step of obtaining at least any one of the number of said characters and the number of said images;
a reading time obtaining step of obtaining the user's reading time on said information; and
a reading time calculating step of calculating, with the use of at least any one of said number of said characters and said number of said images, a reading time per character/image.

10. The evaluating method as claimed in claim 9, further comprising:
an operation information obtaining step of obtaining operation information concerning operation of the user made on said information display apparatus, wherein:
said reading time calculating step corrects the reading time per character/image, with the use of said operation information.

11. The evaluating method as claimed in claim 10, wherein:
a state of said information, said reading time on the information or said operation information is transmitted from said information display apparatus.

12. The evaluating method as claimed in claim 9, wherein:
when the reading time per character/image calculated in said reading time calculating step is equal to or more than a predetermined time, it is determined that the user has not actually read said information.

13. The evaluating method as claimed in claim 9, wherein:
said information comprises link information prepared for the user to link to other information.

14. The evaluation method as claimed in claim 13, wherein:
said reading time calculating step calculates the reading time per character/image based on at least any one of the number of characters and the number of images included from the top to the link information provided in said information when the user has read said other information with the use of said link information.

15. The evaluation method as claimed in claim 13, wherein:
said reading time calculating step calculates a time duration from a time at which the user has started reading of said information to a time at which the user has started reading said other information with the use of said link information, as the reading time on said information.

16. A computer readable information recording medium storing a program for causing a computer to evaluate information which is submitted to an information display apparatus which a user operates, and comprises characters and images, said program comprising instructions for causing the computer to carry out:
a state obtaining step of obtaining at least any one of the number of said characters and the number of said images;
a reading time obtaining step of obtaining the user's reading time on said information; and
a reading time calculating step of calculating, with the use of at least any one of said number of said characters and said number of said images, a reading time per character/image.

17. The computer readable information recording medium as claimed in claim 16, wherein said program further comprises the instructions to cause the computer to carry out:
an operation information obtaining step of obtaining operation information concerning operation of the user made on said information display apparatus, wherein:
said reading time calculating step corrects the reading time per character/image, with the use of said operation information.

18. The computer readable information recording medium as claimed in claim 17, wherein:
a state of said information, said reading time on the information or said operation information is transmitted from said information display apparatus.

19. The computer readable information recording medium as claimed in claim 16, wherein:
when the reading time per character/image calculated in said reading time calculating step is equal to or more than a predetermined time, it is determined that the user has not read said information.

20. The computer readable information recording medium as claimed in claim 16, wherein:
said information comprises link information prepared for the user to read other information.
